(19) United States
(12) Patent Application Publication
(10) Pub. No.: US 2014/0019094 A1
(43) Pub. Date: Jan. 16, 2014

(54) METHODS AND SYSTEMS FOR INVESTIGATING RADIOACTIVE SOURCES IN LOCATIONS

(71) Applicant: Daniel Parvin, Whitehaven (GB)

(72) Inventor: Daniel Parvin, Whitehaven (GB)

(73) Assignee: BABCOCK NUCLEAR LIMITED, London (GB)

(21) Appl. No.: 14/007,395

(22) PCT Filed: Mar. 21, 2012
(86) PCT No.: PCT/GB2012/050616

§ 371 Date: Sep. 25, 2013

(30) Foreign Application Priority Data
Mar. 31, 2011 (GB) 1105450.9

(51) Int. Cl. G01N 23/00; G06N 5/00

(52) U.S. Cl. CPC G01N 23/00; G06N 5/00
USPC 702/189

(57) ABSTRACT

A method and system are provided for more accurately and reliably characterising radioactive activity sources within a material through the use of a measurement data set from the detected emissions which is compared with a computed data set produced by a model of the location to which one or more candidate solutions for the position and/or activity for one or more model activity sources are provided. Optimisation of the match between the two data sets provides, for the characterisation.

This invention concerns improvements in and relating to methods and systems for investigating radioactive sources in locations.

In a wide variety of situations, it is beneficial to be able to investigate radioactive sources within a location. The results of such an investigation are useful for safe operation of a location and its environments, in monitoring past or ongoing processes at the location or in its environments and/or in determining future courses of action for the location or its environments.

A variety of existing methods and systems for investigating radioactive sources exist. However, the cost and complexity of the systems offering the best perfomiance make them unattractive for a variety of situations. In the case of lower cost methods and systems, the extent of the compromise on performance makes them unattractive for many situations.

The present invention has amongst its aims to potentially provide a better balance between cost and performance. The present invention has amongst its aims to potentially provide more accurate results and/or results which have a lower level of uncertainty associated with them.

According to a first aspect of the invention there is provided a method of investigating for one or more activity sources in a location, the method comprising:

a) providing a detector device;

b) detecting one or more emissions from one or more of the activity sources in the location using one or more measurement positions, thereby giving a measured emission set;

c) providing a model of the location;

d) using the model to provide a computed emission set for one or more model activity sources;

e) varying the computed emission set to improve the correspondence between one or more characteristics of the detected emission set and the computed emission set;

f) calculating a calibration factor from a computed emission set which provides an improved correspondence;

g) providing a declared result for one or more of the one or more activity sources which is calculated using the calibration factor.

The first aspect of the invention may further provide one or more of the following. The method may provide a location. One or more of the emissions from one or more activity sources may be detected from a measuring position. One or more further measuring positions may be used to detected one or more emissions from one or more activity sources. The measured emission set may provide a measurement data set. The measurement data set may be provided by combining one or more measured emission sets. The computed emission set may provide a computed data set. The computed data set may be provided by combining one or more computed emission sets. The one or more computed emissions sets, preferably as computed data sets, may be provided by considering one or more candidate solutions for the position and/or activity for one or more model activity sources. The method may include comparing one or more or all the measured emission sets, preferably as a measurement data set, with one or more or all of the computed emission sets, preferably as a computed data set. The comparison may be provided to obtain a measure of the match between one or more or all the measured emission sets, preferably as a measurement data set, with one or more or all of the computed emission sets, preferably as a computed data set the measurement data set and the computed data set. The method may provide for making a decision based upon the comparison, preferably based upon the measure of the match. The method may include making one decision. The making of the one decision may result in one or more steps in the method being repeated. The one decision may result in a further computed data set being provided and/or being compared with the measurement data set and/or a further comparison and/or a further decision. The method may provide for making an another decision. The making of the another decision may result in the method progressing to a further step, for instance providing a declared result.

According to a second aspect of the invention there is provided a method of investigating for one or more activity sources in a location, the method comprising:
a) providing a detector device;
b) providing a location;
c) detecting at a measurement position one or more emissions from one or more of the activity sources;
d) detecting at one or more further measurement positions one or more emissions from one or more of the activity sources;
e) providing a measurement data set from the detected emissions;
f) providing a model of the location;
g) providing one or more candidate solutions for the position and/or activity for one or more model activity sources;
h) using the model to provide a computed data set;
i) comparing the measurement data set with the computed data set to obtain a measure of the match between the measurement data set and the computed data set;
j) making a decision based upon the measure of the match;
k) given one decision, repeating at least steps g) to j);
l) given another decision, providing a declared result.

The second aspect of the invention may further provide one or more of the following. The method may provide, for instance as a part of step i), improving the correspondence between one or more characteristics of the measurement data set and the computed data set. The one or more characteristics may be or include one or more of: activity source position; activity source activity; total activity for all activity sources. The method may include calculating a calibration factor from the computed data set, potentially considered as a computed emission set, which provides an improved correspondence. The method may include providing a declared result for one or more of the one or more activity sources which is calculated using the calibration factor. The method may include calculating a calibration factor from the computed data set, potentially considered as a computed emission set, which provides the another decision. The method may include providing a declared result for one or more of the one or more activity sources which is calculated using the calibration factor.

According to a third aspect of the invention there is provided a system for investigating for one or more radioactive sources in a location, the system comprising:

a) a detector device, the detector being adapted to detect one or more emissions from one or more of the activity sources in the location using one or more measurement positions, thereby giving a measured emission set;

b) a processor, the processor being provided with a model of the location, the processor being adapted to use the model to provide a computed emission set for one or more model activity sources;

c) a further processor, the further processor being adapted to vary the computed emission set to improve the correspondence between one or more characteristics of the detected emission set and the computed emission set;

d) a still further processor, the still further processor being adapted to calculate a calibration factor from a computed emission set which provides an improved correspondence;

e) an output, the output being adapted to provide a declared result for one or more of the one or more activity sources which is calculated using the calibration factor.

According to a fourth aspect of the invention there is provided a system for investigating for one or more radioactive sources in a location, the system comprising:

a) a detector device, the detector being adapted to detect at a measurement position one or more emissions from one or more of the activity sources and to detect at one or more further measurement positions one or more emissions from one or more of the activity sources, the detector device and/or a component connected thereto being adapted to provide a measurement data set from the detected emissions;

b) a processor, the processor being provided with a model of the location, the processor being further provided with one or more candidate solutions for the position and/or activity for one or more model activity sources, the model being adapted to provide a computed data set;

c) a further processor, the further processor being provided with a comparator, the comparator being adapted to compare the measurement data set with the computed data set to obtain a measure of the match between the measurement data set and the computed data set, the further processor being adapted to making a decision based upon the measure of the match, the further processor being adapted to make one decision or another decision, the further processor being adapted to provide or caused the processor to be provided with another one or more candidate solution in response to a one decision, the further processor being adapted to provide a declared result in response to an another decision.

The first and/or second and/or third and/or fourth aspects of the invention may include any of the features, options or possibilities set out elsewhere in this document, including method steps or processes to implement them and/or apparatus to perform them.

The investigation may provide a measurement of one or more characteristics of the activity source. The one or more characteristics may include information about the activity source. The one or more characteristics may include may be the position of the activity source or positions of the activity sources. A position may be expressed in terms of coordinates, preferably relative to a reference location or axes. A position may be expressed in terms of distance and/or one or more angles, preferably relative to a reference location or one or more axes. The one or more characteristics may include the quantity of the activity source or quantities of the activity sources. The quantity may be the mass of the activity source or one or more isotopes thereof. The quantity may be the activity of the activity source or the activity at one or more energies. The investigation may provide a radiometric inventory for the location. The investigation may provide a distribution of the activity source or activity sources within at the location. The distribution may be expressed in terms of position and/or activity.

The investigation may provide a measurement of one or more emitted characteristics of the activity source(s) by applying a calibration factor to one or more detected characteristics of the activity source(s), for instance the one or more detected characteristics of the activity source(s) in the declared result(s). The one or more detected characteristics of the activity source(s) may be or include the count rate. The one or more emitted characteristics of the activity source(s) may be the count rate. The one or more characteristic of the detected activity sources may be converted to being the one or more characteristics of the emitted sources according to the equation:

$${A}^{PSIM} = \frac{{C}_{T}}{{θ}_{PSIM}} \qquad [ 19 ]$$

The investigation may provide a measure of one or more characteristics, for instance emitted characteristics and/or detected characteristics, of the activity source(s) by further processing one or more of the characteristics of the one or more declared results. The one or more declared results may include one or more characteristics for the one or more activity sources which include an activity value for one or more or each of the one or more activity sources. The further processing of the one or more characteristics may provide one or more total activities for the one or more activity sources, preferably for all. The further processing of the one or more characteristics may include considering one or more or all of the total activities to define an optimized result, for instance an optimized total activity and/or a mean total activity and/or a median total activity and/or characteristic of the distribution of values for such total activities. The one or more detected characteristics of the activity source(s) may be or include the count rate. The one or more emitted characteristics of the activity source(s) may be the count rate. The one or more characteristics of the detected activity sources may be converted to being the one or more characteristics of the emitted sources using a term applied to the detected activity sources.

The investigation may provide a measurement of one or more emitted characteristics of the activity source(s) from the one of more detected characteristics of the activity source(s) by applying a factor accounting for the detector device efficiency, for instance the intrinsic detector device efficiency, and/or a calibration factor, for instance a calibration efficiency, such as a calibration efficiency accounting for the location.

The investigation may provide a measurement of the total activity for one or more or all of the activity sources in the location, potentially with an uncertainty range there for and/or an upper and/or lower uncertainty value.

The investigation may provide one or more visual representations, such as an image, of one or more or all activity sources and/or their positions and/or their activities. The visual representations may be 2D and/or 3D.

The investigation may provide information on the measurement accuracy obtained and/or on the measurement uncertainties, preferably associated with the declared results, such as a distribution of activity sources. The investigation may provide information on the position uncertainty and/or activity uncertainty. The investigation may quantify one or more uncertainties, for instance the position uncertainty and/or activity uncertainty. The uncertainty may be a respect of the declared result and/or one or more results within the declared result, for instance for one or more individual activity sources in the declared result.

The location may be a surface or a volume. The location may be a room, cell or building structure, inside of a building or a part of any one thereof. The location may be an item. The item may be a container, such as a bag, drum or the like. The item may be a process location, such as a glove box, conduit or the like. The location may have been exposed to radioactive material and/or used in the processing or storage of radioactive material. The location may be a container provided with waste. The location may include one or more non-radioactive materials and/or one or more radioactive materials. The radioactive material may, whole or in part, be provided within a matrix material.

The activity sources may emit one or more forms of emission, for instance neutrons, alpha particles, beta particles or gamma rays. The activity sources may emit at one or more different energies or ranges of energies. The activity sources may be uranium containing. The activity sources may be plutonium containing.

A single detector device may be provided or used. The single detector device may be provided at one or more, and preferably at a plurality, of measurement positions. Preferably the single detector device is moved between measurement positions during the method's performance and/or during repeats thereof. The movement may be provided by moving the detector device and/or by moving the location, for instance by rotation.

A plurality of detector devices may be provided or used. Preferably each detector device is provided at a different measurement position. A plurality of measurement positions may be provided. Preferably each detector device remains at the measurement position during, the methods performance and/or during repeats thereof.

One or more characteristics of one or more, preferably all, of the measurement positions may be provided. The one or more characteristics may include the position of the measuring position, for instance defined by coordinates and/or a combination of one or more distances and angles. The position may be defined with reference to a front face of the detector device when at the measuring position.

The detector device may be sensitive to and/or detect one or more forms of emission from the activity source, for instance neutrons, alpha particles, beta particles or gamma rays. The detector device may be sensitive to and/or detect one or more different energies or ranges of energies. The detector device may be sensitive to and/or detect uranium and/or plutonium and/or one or more isotopes thereof.

The detector device may have a detection efficiency, particularly an intrinsic efficiency. The detection efficiency may be function of incident emission energy, such as incident gamma ray energy. The intrinsic efficiency of a detection device may be determined, preferably using one or more known sources. Preferably the one or more known sources are of a known activity and/or emission energy or range of energies. The intrinsic efficiency of a detection device may be established outside of the method or as a step within the method. The measurement data set and/or the measured emission set and/or the measured count and/or the measured count rate or more than one of these may be corrected according to the intrinsic efficiency. The correction for the intrinsic efficiency may be made in addition to the correction using the calibration factor. The intrinsic efficiency and the calibration factor, preferably as a calibration efficiency, are used to correct the detected emissions to give the emitted emissions, potentially expressed as a count rate and/or count and/or activity.

The detection device may generate one or more signals in response to one or more emissions which interact with the detector device. The one or more signals may be used to generate a measurement data set.

The measurement data set may include one or more of count rate at an energy; count rate at a range of energies; total count rate, for instance at all energies the detector device is sensitive to. The measurement data set may include for a plurality, and preferably for all, measurement positions, separate values for one or more of: count rate at an energy for a measurement position; count rate at a range of energies for a measurement position; total count rate for a measurement position, for instance at all energies the detector device is sensitive to. The measurement data set may include a total count rate for all measurement positions combined.

The measurement data set may include one or more sub-sets of measurement data, with a sub-set being in respect of a particular form of emission, when compared with one or more other sub-sets and/or with a sub-set being in respect of a particular energy or range of energies of emission, when compared with one or more other sub-sets and/or with a sub-set being in respect of a particular isotope or group of isotopes, when compared with one or more other sub-sets.

The measurement data set may include one or more comparable terms. The one or more comparable terms of the measurement data set may be the same as one or more of the comparable terms provided by the computed data set, preferably all computed data sets. The one or more comparable terms may be or include: count rate at an energy; count rate at a range of energies; total count rate, for instance at all energies the detector device is sensitive to.

The model may be a mathematical model. The model may define a search space. The model may provide a model location geometry which is an approximation of the location and particularly the actual location geometry for that location. The model may provide an approximation of the location in terms of one or more characteristics of the location. The one or more characteristics may include one or more of: materials defining the location; materials in the location; attenuation properties of one or more or all of the materials defining the location and/or in the location; radiological shielding properties of one or more or all of the materials defining the location and/or in the location; the mass of material defining the location and/or in the location; the geometry of one or more or all surfaces or parts thereof defining the location and/or in the location; one or more or all of the measurement positions; the size and/or orientation of elements defining the location and/or provided in the location.

The model may provide for an approximation of the surfaces or other geometric features of the location. The model may provide an approximation for the location expressed in terms of one or more quadric surfaces. The model may provide for an approximation of one or more characteristics of one or more sub-volumes, such as cells, for the location. The location, and particularly the volume there of, may be divided into a plurality of sub-volumes, such as cells. One or more of the sub-volumes may be characterised in terms of the density value for that sub-volume and/or the attenuation coefficient for that sub-volume. One or more constraints may be applied to one or more of the sub-volumes defined for the location. The one or more constraints may be or include that an activity source can be positioned in the sub-volume, particularly in the context of the optimisation step and/or comparison step and/or computed data set. The one or more constraints may be or include that an activity source cannot be positioned in the sub-volume, particularly in the context of the optimisation step and/or comparison step and/or computed data set. The activity source may not be allowed where the sub-volume is or is a part of the container for a matrix and/or activity sources. The activity source may not be allowed where the sub-volume is or is a part of the environments around a container and/or matrix and/or activity source(s).

The model may provide an at least partial account for the influence of one or more aspects of the location on the detection of emissions by a detection device. This may be in respect of the influence at one or more or all of the measurement positions. This may be in respect of the influence of attenuation. This may be in respect of the influence shielding. This may be in respect of the influence of geometry. This may be in respect of the influence of materials. This may be in respect of the influence of position of an activity source within the location. This may be in respect of the influence of the positions for a plurality of activity sources within the location. This may be in respect of the influence of the activity of an activity source within the location. This may be in respect of the influence of the activities of a plurality of activity sources within the location.

The model may consider one or more or all of the following when determining the computed data set, and in particular the computed emissions contributing to the computed data set: the path length between the activity source and the detector device; the path orientation between the activity source and the detector device; one or more characteristics of the material or materials between the activity source and the detector device, for instance in terms of the material density and/or attenuation coefficient.

The model may determine one or more or all of computed data sets, particularly the computed emissions contributing to the computed data set, according to the equation:

$$\hat{C} = \frac{{A}_{d} cos ( μ ) {ɛ}_{int} {A}_{source}}{4 {π ( {d}_{1} + {d}_{2} + {d}_{3} )}^{2}} \times exp - ( {μ}_{1} {ρ}_{1} {d}_{1} + {μ}_{2} {ρ}_{2} {d}_{2} ) \qquad [ 29 ]$$

The model may be provided with one or more inputs. The one or more inputs may be provided by the user. The one or more inputs may be provided to the model by the results of another method. The one or more inputs may be selected by the model itself. The one or more inputs may be provided by another stage of the method, for instance a computational method or stage that implements a computational method.

The one or more inputs may include information on one or more of the search space; a model location geometry which is an approximation of the location; an approximation of the location in terms of one or more characteristics of the location. The one or more inputs may include information on one or more characteristics and may include information on one or more of: materials defining the location; materials in the location; attenuation properties of one or more or all of the materials defining the location and/or in the location; radiological shielding properties of one or more or all of the materials defining the location and/or in the location; the mass of material defining the location and/or in the location; the geometry of one or more or all surfaces or parts thereof defining the location and/or in the location; one or more or all of the measurement positions; the size and/or orientation of elements defining the location and/or provided in the location.

The one or more inputs may include one or more candidate solutions for the position and/or activity for activity sources which gave rise to the measurement data set.

The one or more inputs may include information on one or more of: one or more positions, particularly within the search space, of activity sources; one or more activities, particularly within the search space, of activity sources.

The one or inputs may provide a population of candidate solutions. The number of activity sources in the population, at least in the first computed data set, may be set by the user and/or the model and/or the computational method.

The one or more inputs, particularly in the case of first inputs, may be used by the model to provide a first computed data set.

The model may provide the first computed data set to a stage in the method, for instance a computational method or stage for implementing that.

The model may be provided with one or more further inputs. The one or more further inputs may be provided by a stage provided with the first computed data set, such as a computational method or stage for implementing that.

The one or more further inputs may be used by the model to provide one or more further computed data sets.

The one or more further inputs may include a change in respect of one or more or all of the inputs to the first computed data set. Preferably, the one or more further inputs are constrained from changing in respect of one or more of the inputs to the first computed data set. Preferably the one or more further inputs are not constrained from changing with respect to: the position of one or more or all of the activity sources; and/or the activity of one or more or all of the activity sources; and/or the number of activity sources.

The model may provide one or more of the one or more further computed data sets to a stage in the method, for instance a computational method or stage for implementing that.

The one or more further inputs may include one or more changes compared with the first computed data set. The one or more further inputs may include one or more changes compared with a previous computed data set. The one or more changes may be in the number of activity sources and/or position of one or more of the activity sources and/or activity of one or more of the activity sources. The one or more changes may be proposed by the stage to which the first computed data set is provided and/or by the computational method or stage for implementing that.

The stage, such as a computational method or stage, provided with the first computed data set and/or one or more further computed data sets by the model may provide one or more processes. Preferably the stage applies the one or more processes to one or more of the first computed data set; the measurement data set; one or more further computed data sets.

The stage may provide a comparison of the measurement data set with a computed data set. The stage may provide a comparison of the measurement data set with the first computed data set and/or one or more further computed data sets. The comparable terms of the measurement data set may be compared with the comparable terms of a computed data set. The comparable terms of the measurement data set may be compared with the comparable terms of the first computed data set and/or one or more of the further computed data sets.

The comparison may provide a measure of the match between the measurement data set and one or more computed data sets.

A comparison which meets one or more parameters may be deemed a solution.

One or more solutions may be provided by the method or repeats thereof. Where a solution is provided, the method may provide for repeating one or more of the method steps, preferably starting with a new set of one or more inputs and/or a new population of candidate solutions. The new set of one or more inputs and/or a new population of candidate solutions may be the same as, or preferably different from, the initial set of one or more inputs and/or a new population of candidate solutions and/or a previous new set of one or more inputs and/or a new population of candidate solutions. The new set of one or more inputs and/or a new population of candidate solutions may differ in respect of one or more or all of the inputs. Preferably the new set differs in terms of the position of an activity source and/or the activity of an activity source for one or more or all of the activity sources. The new set may differ in terms of the number of activity sources.

The comparison may seek to minimise the value of OBJ in the function:

$$OBJ ( p ) = {\sum }_{j = 1}^{M} {( \frac{{C}_{j} - {\hat{C} ( p )}_{j}}{{C}_{j}} )}^{2} \qquad [ 23 ]$$

One or more of the solutions may provide information to and/or be reported in the declared result or results. A comparison which meets one or more of the parameters may cause the computational stage to stop and/or the method to progress to a results stage. A comparison which meets one or more of the parameters may cause the computational stage to stop and/or the method to progress to a results stage where the number of solutions and/or number of matches and/or number of repeats of the method meets or exceeds a limit. The limit may be set by the user and/or by the computational stage.

A comparison which does not meet one or more of the parameters may not be deemed a solution. A comparison which does not meet one or more of the parameters may cause the method to continue. The method may continue by repeating one or more of the steps. The method may continue by one or more of changing one or more of the candidate solutions in the population of candidate; adding or removing one or more candidate solutions in the population of candidate; providing further inputs to the model, for instance reflecting changes in the population of candidate solutions; providing one or more further computed data sets to the computational stage; making one or more comparisons. The method may provide one or more iterations for the computed data set. Each iteration may provide one or more of: changing one or more of the candidate solutions in the population of candidate; adding or removing one or more candidate solutions in the population of candidate; providing further inputs to the model, for instance reflecting changes in the population of candidate solutions; providing one or more further computed data sets to the computational stage; making one or more comparisons.

A comparison may meet one or more of the parameters where the comparison falls within a range defined for that parameter. The range may be defined about the ratio of the measurement data set to the computed data set or one or more values thereof. The one or more values may be the total measured count rate or count to the computed count rate or count, or the inverse thereof. The range may be defined by an equation for an upper limit and/or an equation for a lower limit.

The method may provide for one or more declared results. The one or more declared results may arise from those computed data sets which are a match for the measurement data set. One or more computed data sets may give rise to a declared result or plurality of declared results. One or more or all of the declared results may provide: one or more activity source positions; and/or one or more activity source activities; and/or one or more total activity for all activity sources. One or more or all of the results may provide: a quantification of the total activity sources present; and/or a quantification of the total activity attributable to one or more isotopes; and/or a quantification of the mass of activity sources present; and/or a quantification of the mass of one or more isotopes.

Particularly according to a first form, the one or more declared results may provide a measurement of one or more emitted characteristics of the activity source(s) by applying a calibration factor to one or more detected characteristics of the activity source(s). The one or more declared results may provide a measurement of the total activity for one or more or all of the activity sources in the location, potentially with an uncertainty range there for and/or an upper and/or lower uncertainty value.

Particularly according to a first form, the calibration factor may relate to the extent of the detected emissions compared with the extent of the emitted emissions. The calibration factor may be a measure of efficiency, for instance the efficiency of the system. The calibration factor may be specific to one or more of: the location; one or more items in the location; one or more or all of the energies or ranges of energy the detector device is sensitive to; the activity source; one or more isotopes of the activity source; one or more types of emission; one or more or all matrix materials in the location; one or more or all shielding materials in the location; one or more or all attenuating materials in the location; one or more or all fields of view of the location; one or more or all fields of view of the detector device; one or more or all of the fields of view from one or more or all of the measurement positions. The method may provide one or more calibration factors, for instance two or more calibration factors where they are specific to different options from amongst those listed in this paragraph.

Particularly according to a first form, the calibration factor may provide and/or allow for a non-uniform distribution of activity sources within the location and/or search space, for instance being non-uniform in terms of position and/or activity.

Particularly according to a first form, the method may provide for the calibration factor, θ_{cal}, being of the form:

$${θ}_{cal} = \frac{{\sum }_{i = 1}^{n} {A}_{i} {θ}_{i} ( x , y , z )}{{\sum }_{i = 1}^{n} {A}_{i}} \qquad [ 7 ]$$

where Aᵢ=activity of source i; θᵢ(x, y, z)=net detection efficiency of source i; and n is the number of activity sources.

Particularly according to a first form, the method may provide for the calibration factor and/or an overall calibration factor, θ_{cal}, being of the form:

$${θ}_{PSIM} = \frac{{\sum }_{k = 1}^{Q} {\sum }_{i = 1}^{n} {A}_{i , k} {θ}_{i , k}}{{\sum }_{k = 1}^{Q} {\sum }_{i = 1}^{n} {A}_{i , k}} \qquad [ 24 ]$$

where A_{i,k}=activity of source i for measurement position k; θ_{i,k}=net detection efficiency of source i for measurement position k; Q is the number of optimisations performed; and n is the number of activity sources.

Particularly according to a first form, the method may provide for the declared results including values for one or two or all three of

$$\begin{matrix}{A}^{Best} = \frac{{C}_{T}}{{θ}_{PSIM}} & [ 15 ] \\ {A}^{Max} = \frac{{C}_{T}}{{\vert {θ}_{PSIM} \vert}^{min}} & [ 16 ] \\ {A}^{Min} = \frac{{C}_{T}}{{\vert {θ}_{PSIM} \vert}^{max}} & [ 17 ]\end{matrix}$$

where A^{Best} is the most likely activity for the activity sources; A^{Max} is the activity corresponding to the positive uncertainty; A^{Min} is the activity corresponding to the negative uncertainty and |θ_{PSIM}|^{max} and |θ_{PSIM}|^{min} the positive and negative uncertainty component associated with θ_{PSIM}.

Particularly according to a first form, the method may provide, in series and/or in parallel with the determination of one or more declared results using a calibration factor which provides and/or allows for a non-uniform distribution of activity sources within the location and/or search space, for instance being non-uniform in terms of position and/or activity, a determination of one or more declared results using a calibration factor which provides for a uniform distribution of activity sources within the location and/or search space, for instance being uniform in terms of position and/or activity. The declared results may include a statement of the activity and/or uncertainty for the two determinations and/or a comparison of thereof.

Particularly according to a preferred second form, the one or more declared results may provide a measurement of one or more emitted characteristics of the activity source(s) and/or one or more detected characteristics of the activity sources, for instance the total activity for instance derived from the individual source activities. The one or more declared results may provide a measurement of the total activity for one or more or all of the activity sources in the location, potentially with an uncertainty range there for and/or an upper and/or lower uncertainty value.

Particularly according to a preferred second form, a declared result may provide an overall characteristic, for instance a total activity, from one or more of the characteristics, for instance one or more source activities, in the declared result. Two or more or all of the declared results may provide an overall characteristic, for instance a total activity, from one or more of the characteristics, for instance one or more source activities, in the declared result. One or more overall characteristics may be further processed, for instance to combine two or more overall characteristics to provide for a processed overall characteristic. One or more total activities may be further processed, for instance to combine two or more total activities to provide a processed total activity. The processed overall characteristic and/or processed total activity may by an optimised version thereof and/or maximum thereof, for instance at a given uncertainty, and/or a minimum thereof, for instance at a given uncertainty. The optimised version thereof may be a mean and/or a median.

Particularly according to a preferred second form, the calibration factor may provide and/or allow for a non-uniform distribution of activity sources within the location and/or search space, for instance being non-uniform in terms of position and/or activity.

Particularly according to a preferred second form, the method may provide for the declared results and/or processed overall characteristic including values for one or two or all three of:

$${A}_{PSIM} = \frac{{\sum }_{k = 1}^{Q} {\sum }_{i = 1}^{n} {A}_{i , k}}{Q} \qquad [ 27 ]$$

for instance as the best measure of total activity;

$${\vert {A}_{PSIM} \vert}^{max} = Percentile ( {[ {\sum }_{i = 1}^{n} {A}_{i} ]}_{All Q} , 1 - α ) \qquad [ 28 ]$$

for instance as a best measure of the maximum total activity;

$${\vert {A}_{PSIM} \vert}^{min} = Percentile ( {[ {\sum }_{i = 1}^{n} {A}_{i} ]}_{All Q} , α ) \qquad [ 17 ]$$

for instance as a best measure of the minimum total activity.

Particularly according to a preferred second form, the method may provide, in series and/or in parallel with the determination of one or more declared results which provides and/or allows for a non-uniform distribution of activity sources within the location and/or search space, for instance being non-unifoun in terms of position and/or activity, a determination of one or more declared results which provides for a uniform distribution of activity sources within the location and/or search space, for instance being uniform in terms of position and/or activity. The declared results may include a statement of the activity and/or uncertainty for the two determinations and/or a comparison of thereof.

The declared result may be present as activity source information only. The declared result may include a combination of activity source information with visual information on the location. The declared result may be formed of a series of 2D representations of the 3D location, for instance a plurality of horizontal slices and/or plurality of vertical slices. The declared result may provide one or more visual representations, such as an image, of one or more or all activity sources and/or their positions and/or their activities. The visual representations may be 2D and/or 3D.

One or more or all of the declared results may have a declared uncertainty. One or more or all of the components, such as position and/or activity, may have an individual declared uncertainty.

The declared results may include one or more statements of uncertainty. A higher or maximum value uncertainty may be stated and/or a lower or minimum value uncertainty may be stated, particularly according to a defined confidence limit. The uncertainty may take into consideration the location; one or more parts of the location; activity source distribution; attenuation, for instance by the matrix and/or activity sources.

The declared results may include an automatically calculated uncertainty or uncertainties. The declared results may provide an uncertainty or uncertainties obtained from the consideration of one or more or all of the activity sources and/or from the consideration of a non-uniform distribution of activity sources within the location and/or search space, for instance being non-uniform in terms of position and/or activity. The declared results may include a statement of and/or take into consideration a limit of detection, preferably with the limit of detection based upon the consideration of one or more or all of the activity sources and/or from the consideration of a non-uniform distribution of activity sources within the location and/or search space, for instance being non-uniform in terms of position and/or activity.

Various embodiments of the invention are now described, by way of example only, and with reference to the accompanying drawing, in which:

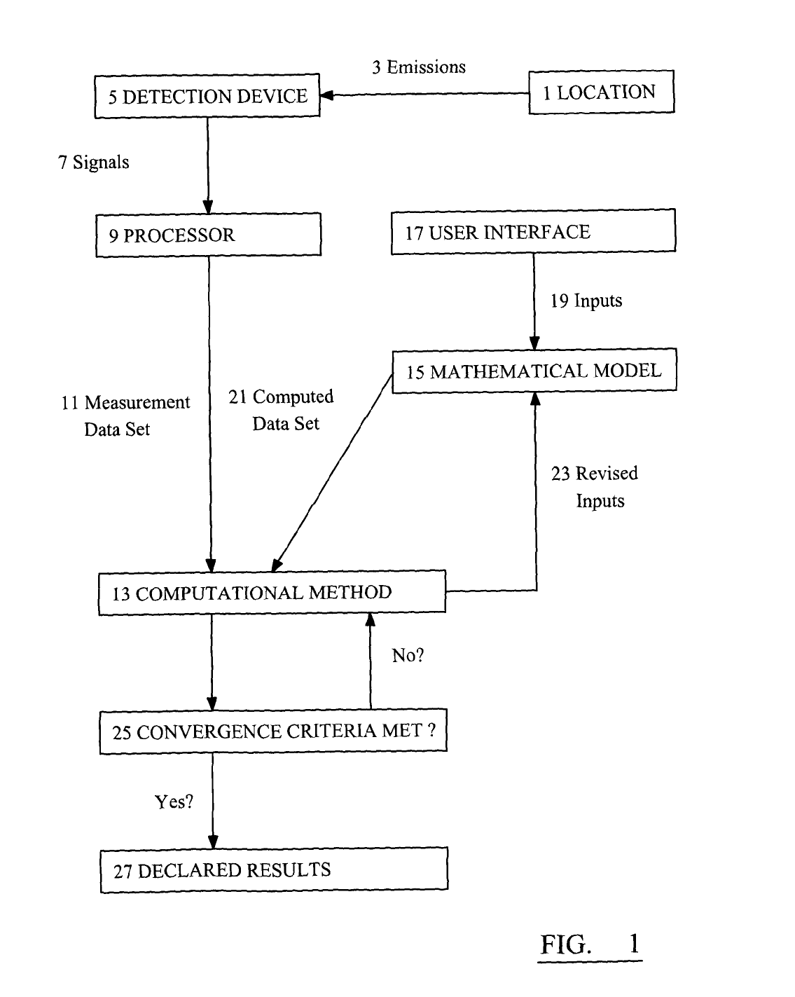

FIG. 1 is a schematic illustration of a methodology according to the present invention;

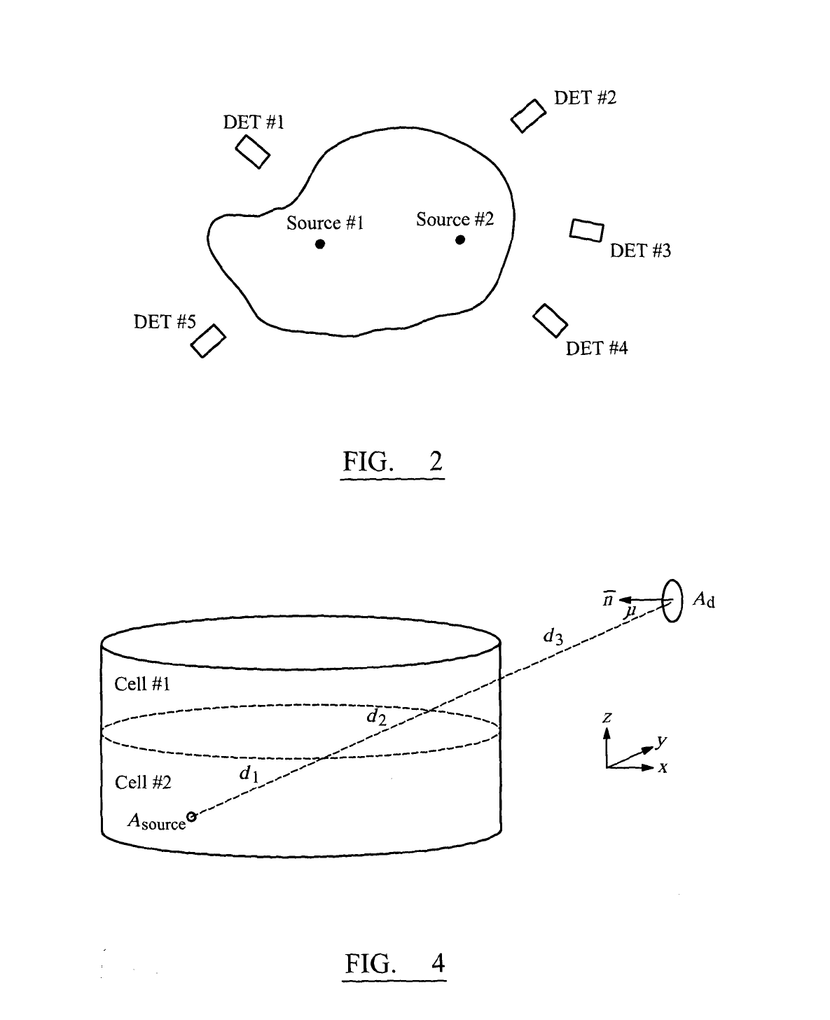

FIG. 2 is a schematic illustration of a measurement arrangement for radiometric investigation of a location using one or more detection devices;

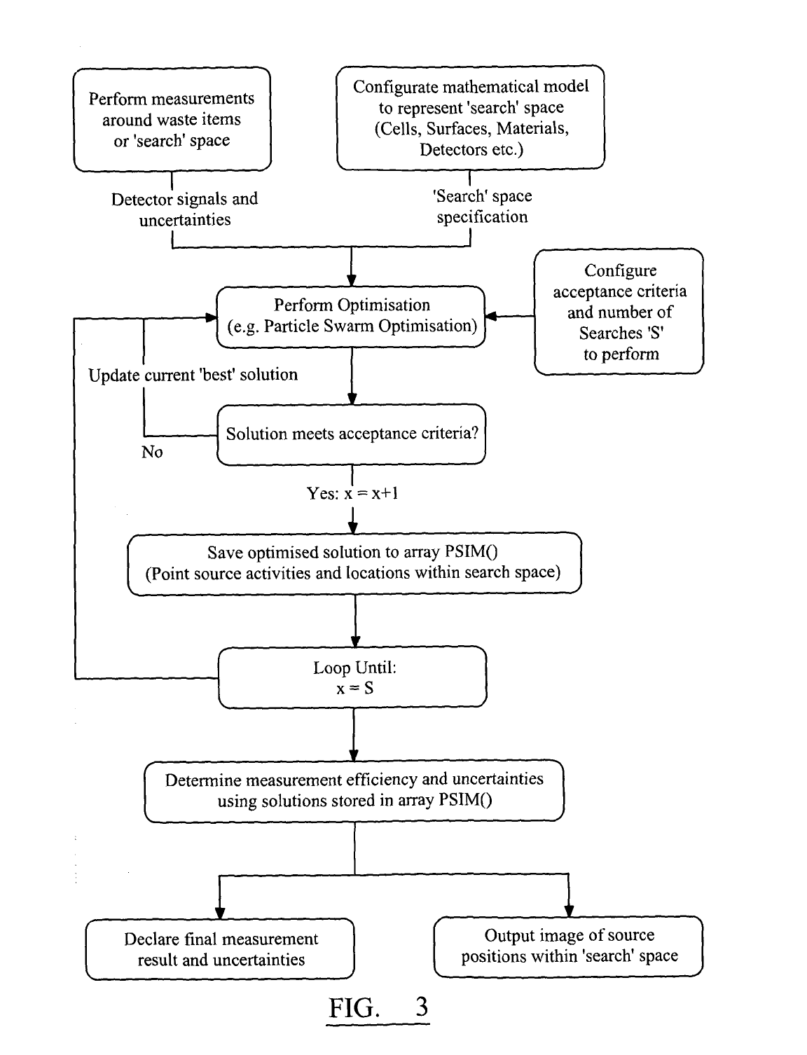

FIG. 3 is a schematic illustration of the steps of the method, with emphasis on the steps in the mathematical model and computational method;

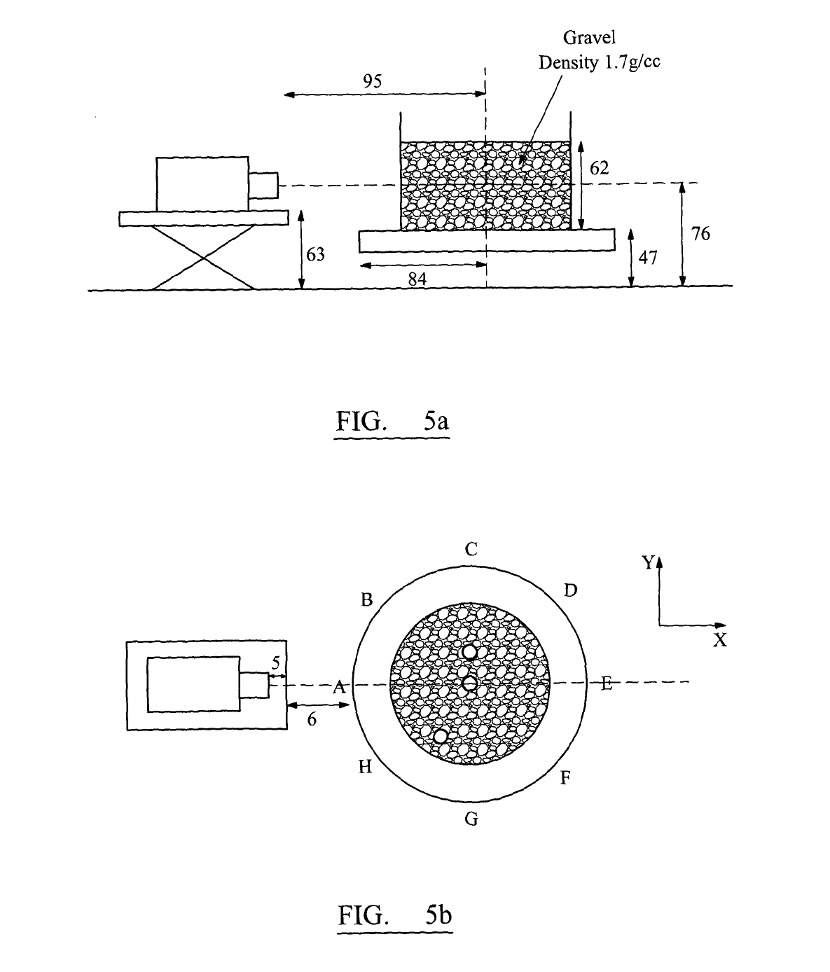

FIG. 4 is a schematic illustration of a gamma-ray system applying an embodiment of the invention;

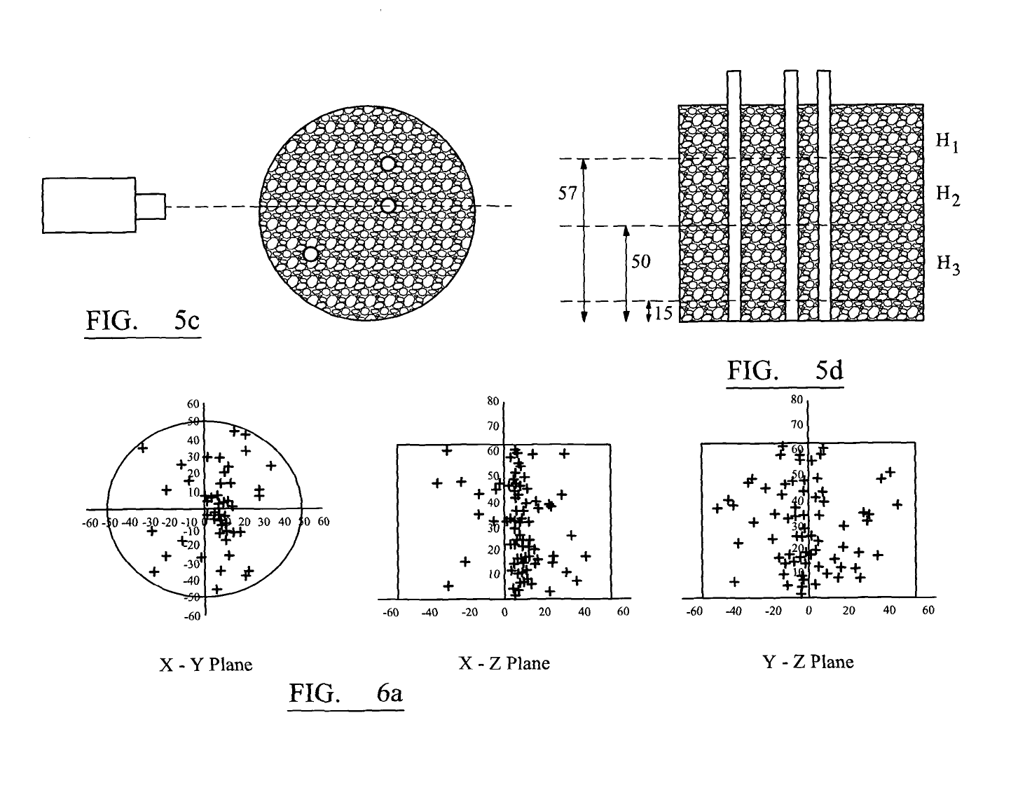

FIG. 5a is a side view of a detector device, location and waste item;

FIG. 5b is a plan view of FIG. 5a;

FIG. 5c is a plan view showing the tubes used for positioning known activity sources in the test device;

FIG. 5d is a side view of FIG. 5c;

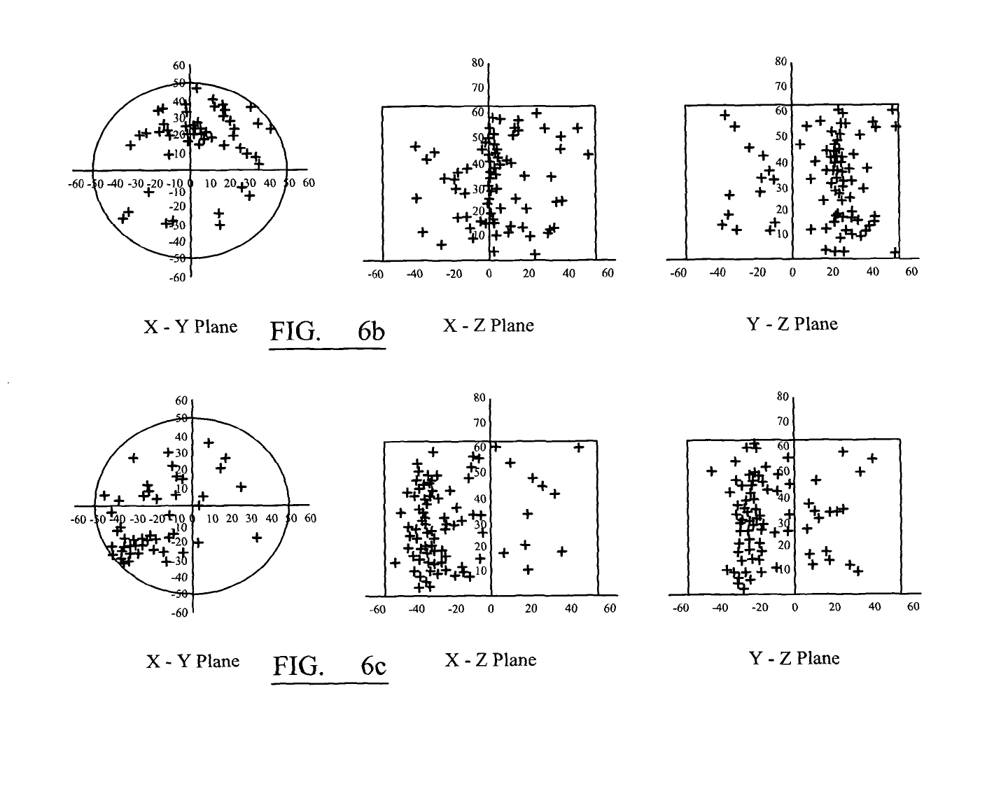

FIG. 6a shows X-Y, X-Z and Y-Z plane visualisations of example test results for an activity source position, X-H1 of FIGS. 5c and d;

FIG. 6b shows. X-Y, X-Z and Y-Z plane visualisations of example test results, for an activity source position, Y-H1 of FIGS. 5c and d;

FIG. 6c shows X-Y, X-Z and Y-Z plane visualisations of example test results for an activity source position, Z-H1 of FIGS. 5c and d.

### PROBLEMS WITH PRIOR ART METHODS

There is an increasing demand for radiometric investigation methods and systems which offer enhanced levels of accuracy and performance, whilst keeping the cost and complexity to a minimum. Such methods and systems are needed to characterise and/or quantify radionuclide inventories within locations. The locations may be waste items (i.e. drums, boxes, crates, glove boxes etc.) and/or more generally extended 3D volumes (i.e. cells, rooms, ponds etc.), potentially including waste items.

Compared to systems employing the accepted ‘state of the art’ techniques, such as tomographic gamma scanners, TGS, and segmented gamma scanners, SGS, the systems of the present invention have the potential to deliver a comparable level of radiometric investigation performance at a significantly reduced cost. These prior art systems are expensive to manufacture, require complex analysis algorithms to function and require significant measurement times to achieve the required performance.

Compared with the lower cost systems presently available, the systems of the present invention address many of the shortfalls and incorrect assumptions, in calibration and/or operation, applied in those systems to operate despite the lower costs of the system used. Often these employ unrealistic assumptions in their calibration methodology leading to results and, more importantly, measurement uncertainties, which are only valid for specific cases. The methods and systems of the present invention offer a level of performance significantly better than most available assay systems, but in manner which is relatively low cost.

In all methods and systems, the measurement accuracy is usually dominated by the measurement uncertainty associated with the distribution of the activity sources, for instance their position and/or activity within the location. This lack of information combined with, for example, the attenuating effect of the location, for instance due to the activity source itself and/or matrix material in the location, inevitably lead to substantial measurement uncertainties. The impact of these are often neglected in the declared results for the investigation, for instance the radionuclide inventory and associated uncertainty.

The present invention aims to address this, providing high levels of accuracy, but with lower costs.

The prior art includes approaches, such as the applicant's DISPIM system detailed in EP1012630, which generate a simulated result and adjust it to match the measured result. It is important to note, however, that such approaches seek to provide a model solution for the activity/activities and position/positions of the activity sources directly. Once a match is obtained between the measured result and the simulated result, that is the end of the process. The values of position and activity for the matching simulated result are used directly. The present invention seeks to obtain a calibration efficiency through the methodology and then make further use of that; not to obtain a simulated result. The prior art also seek a single optimised solution as their result; the present invention seeks multiple optimised solutions which can then be combined, both when the calibration efficiency approach and the activities of the sources approach are used to give the total activity. Both are describe din more detail below.

### Overview of the Invention

The present invention provides methods and systems, and in particular method and systems for imaging the distribution of radioactive sources within a location, such as a volume, which can be applied to many radiometric investigations. The methods and systems have been verified in terms of their performance using simulated and ‘real’ measurement data.

A key advantage of the invention is that it's very generic nature allows its application in a wide variety of investigations and in a wide range of situations encountered in such investigations. Examples of these are detailed below.

The method provides imaging of the position and source activity of any sources provided within the location, such as a waste item. As a consequence, the method provides declared results which include a comparable level of information to methods such as TGS.

The method and system are illustrated schematically in FIG. 1.

The location 1 gives rise to emissions 3 which are detected at the detection device 5 and provide the signals 7 to a signal processor 9 and hence give the measurement data set 11. The method and system provide the measurement data set 11 to the, preferably computer implemented, computational method 13 described further below.

The method and system also include a, preferably computer implemented, mathematical model 15 which can be configured by the user, interface 17 and inputs 19, to model the actual location geometry in terms of a model location geometry. The model may be provided in a processor or other electronic device. A search space is defined for the method which corresponds to the location being considered in the physical world. The actual location geometry is that for which measurements are taken. The mathematical model 15 can hence be used to establish a computed data set 21 which is provided to the computational method 13.

The method and system also include the computational method 13 which iteratively seeks to improve the match between the measurement data set 11 it receives and the computed data sets 21 it receives. The computational method may be provided in a further processor or other further electronic device. The computational method 13 undertakes iterations, provides revised inputs 23 to the mathematical model 15 and these revised inputs are used in determining further computed data sets 21. The further computed data sets 21 are used in further comparisons and so the method works through many iterations to a declared result or results. For each comparison, convergence criteria 25 are used to define when the better matches or best match have been achieved. If the answer is yes, then the computational method 13 gives the declared results 27 based upon the better matches or best match achieved. If the answer is no, then the computational method 13 goes through a further iteration and the repeats the convergence review. The further processor or other further electronic device may provide the comparisons. The processor or other further electronic device may be the same as the further processor or further electronic device. The declared results may be considered further by one or more of these processors or devices.

The declared results 27, in the form above are useful in themselves, but can be considered further in reaching further forms for the declared results.

Thus, the declared results 27 can provide, in particular, a calculated calibration efficiency. The calculated calibration efficiency can be used to correct the measured activity to give the actual activity present, the emitted activity, as a part of the declared results.

Alternatively, the declared results 27 can be used directly to give their total activities and from that a set of total activity solutions, the best total activity solution.

Each of these parts of the method and system are now described in more detail. The details on the parts of the method and system are supplemented by information and explanation on the approach taken in certain cases.

### Measurement Arrangement

To illustrate the invention, the schematic illustration of FIG. 2 is considered. This includes a location 101 including a volume of matrix material 103 and activity sources 105a, 105b. The location 101 is investigated using a detector device 107. Multiple measurements for the location 101 can be obtained, either by taking a measurement with the detector device 107 at each of the different measurement positions 109 or by providing a different detector device 107 at each of the measurement positions 109. In FIG. 2, five detector devices 107 are shown or five measurement positions 109. The location contains two point sources as the activity sources 105a, 105b.

Generically expressed, such a measurement arrangement provides a series of measurements, M, each expressed as a total measured count rate, C_{T}, for the location (x, y, z) which contains a number, n, of activity sources.

Each particular activity source, j, has an activity of source, Aⱼ. Each of the measurements M has a count rate, Cᵢ, for each of the measurement positions, i. Each of the measurement positions, i, whether considered using different detector devices or the same detector device, has a detection efficiency, ε_{i,j}(x, y, z), for each activity source, j, with respect to measurement position, i. With respect to each activity source, j, there is also a net detection efficiency, θᵢ(x,y,z).

Hence, the total measured count rate can be expressed as:

$${C}_{T} = {\sum }_{j = 1}^{M} {C}_{j} = {\sum }_{j = 1}^{M} {\sum }_{i = 1}^{n} {A}_{i} {ɛ}_{j , i} ( x , y , z ) = {\sum }_{i = 1}^{n} {A}_{i} {θ}_{i} ( x , y , z ) \qquad [ 1 ]$$

and the uncertainty can be expressed as:

$${σC}_{T} = \sqrt{{\sum }_{j = 1}^{M} {( {σC}_{j} )}^{2}} \qquad [ 2 ]$$

where
Cⱼ=count rate measured by detector or measurement position j
σCⱼ=1σ uncertainty associated in the count rate measured by detector or measurement position j
Aᵢ=activity of source i
ε_{j,i}(x, y, z)=detection efficiency of point source i with respect to detector or measurement position j
θᵢ(x, y, z)=net detection efficiency of source i.

### Mathematical Model

The mathematical model 15 provides a model location geometry which represents the actual location geometry. The mathematical model is computer implemented with respect to its generated, revision and use. The mathematical model 15 is versatile and places no restrictions on the model location geometry so allowing it to be an accurate model for the actual location 1 geometry. The model defines a search space which relates to the location 1 being considered in the physical world. The search space is accurate as it includes model features for features in the location 1 and parts thereof. Thus model features such as the search space including a volume which includes the waste item, with that provided on top of another item and within a room can be modelled fully. The model 15 describes the model features in terms of groups of quadric surfaces. Hence, the model features and/or model location geometry are not restricted to a set of pre-configured forms, as in some commercially available assay systems. The model 15 is capable of modelling common geometrical configurations such as drums, crates, Isofreight containers and glove boxes, as well as more complex geometries involving multiple items and asymmetrical geometries, all of which can be easily configured by the user.

Using the mathematical model 15 it is possible to establish the computed data set 21 which represents the outcome from the interaction between the model distribution of model activity sources and the model location geometry. By providing revised inputs 23 to the mathematical model 15 revised computed data sets 21 can be obtained. The revised inputs 23 can come from the computational method 13 as part of its iterative seeking of optimised solutions.

The actual form of model 15 used and its implementation are not limiting. The model 15 needs to be able to calculated the computed data sets 21 from the inputs 19, 23 in a meaningful way, but various models 15 can be used for this purpose without deviating from the invention's methodology.

One of the key purposes of the mathematical model 15 is to enable consideration of a function defined as calibration efficiency. This is explored further below.

### Computational Method

The computational method 13 considers the computed data set 21 and the measurement data set 11 in comparable terms. The computational method is computer implemented with respect to its generated, revision and use. The comparable terms are obtained by the computational method 13 considering the form of the comparable terms, provided when a population of candidate solutions are considered, against the comparable terms of the measurement data set 11. The population of candidate solutions is iteratively changed to give a revised population of candidate solutions. These provide the revised inputs 23 for the mathematical model 15. The mathematical model 15 provides revised comparable terms in a revised computed data set 21.

In each comparison performed by the computational method 13, comparable terms are compared with the terms of the measurement data set 11 to establish the match extent. The match extent may be compared with a threshold or other known form or criteria to identify a match; convergence criteria 25. The population of candidate solutions relate to the position and activity for each candidate solution present in the population. Multiple repeats of the optimisation (the loop including steps 13, 15 and 25 for instance) may be provided to give multiple solutions. The multiple solutions may be combined to give an average solution and this may be used in the calculation of the overall calibration efficiency (equation 24 below); declared results 27. The multiple repeats of the optimisation seek all credible solutions and give a weighted average. The spread determines the uncertainty. This approach also holds true for the alternative forms of the computational method described below. The approach can also be used where the multiple solutions are not used to give a calibration efficiency, but rather where the multiple solutions are used to determine their distribution of activities and hence a solution for the total activity directly. This alternative form is also described in more detail below.

The preferred computational method 13 is based around an optimization using the technique of Particle Swarm Optimization, PSO, by iteratively trying to improve a population of candidate solutions with regard to a given measure of quality. The measure of quality is based upon a comparison of the population of candidate solutions, the computed data set 21, against the measurement data set 11 obtained by considering the measured signals 7 obtained from multiple measurement positions, recorded externally or internally, for a defined location 1.

Here a measured signal 7 may equal a measured gamma-ray or neutron count rate, dose measurement or any quantifiable signal that is in some way related to the strength of single or multiple sources within the location 1. The location 1 may be any defined shape or volume. Examples of typical locations may be the internal volume or subset of the volume of a drum, crate, Isofreight etc. Larger locations may be considered, such as rooms etc.

PSO optimizes a problem by having a population of candidate solutions, or particles, and moving these particles around in the search space according to simple mathematical formulae, detailed in various papers, including those stated below. The movements of the particles are guided by the best found positions in the search space which are updated as better positions are found by the particles. The modified form of PSO detailed and its application are based upon the original details for PSO provided in Kennedy, J.; Eberhart, R. (1995). “Particle Conference on Neural Networks, IV, pp. 1942 Swarm Optimization”, Proceedings of IEEE International—1948.

The basic PSO algorithm works by having a population (often called a swarm) of candidate solutions (often called particles). These particles are moved around in the search space. The movements of the particles are guided by their own best known position in the search-space as well as the entire swarm's best known position. When improved positions are discovered these will then come to guide the movements of the swarm. The process is repeated until a satisfactory solution is discovered (i.e. a good match to the measurement data set 11 obtained from the detector device suggesting that the population of candidate solutions in the search space is a good match for the activity sources in the location 1). The populations of candidate solutions which are a good enough match are deemed solutions. The solutions include activity source position and strength within the search space. The establishment of the solutions is discussed further in the convergence criteria section below. It is preferred that multiple solutions are generated from multiple PSO optimisations which are combined to calculate the calibration efficiency and hence the total source strength within the search space and to generate a pseudo-image of the distribution within the search space.

One way to think of the method is finding where the activity source strength density is greatest within the search space. Alternatively it can be considered as a method of finding where the activity source strength density is least or is not located within the search space.

In order to be able to perform the comparison, it is necessary to generate a computed data set for the candidate solutions. As described above, this is achieved through a mathematical model 15. The mathematical model 15 is constructed such that the activity source positions and strengths of any candidate solution within the search space can be used to generate a computed data set 21 (which may be expressed as theoretical signals against which the measured signals, but are preferred as estimated count rates against measured count rates) which can be compared and a measure of quality calculated. The mathematical model 15 can be based upon the physical transport of the signal to the detector device or a pre-defined efficiency map for the search space itself or a specific detector device efficiency characterisation.

As mentioned above, the preferred optimisation approach employs the Particle Swarm Optimization, PSO, in the computational method. This computational method optimizes by iteratively advancing from a population of candidate solutions, through other configurations for that population of candidate solutions to a revised population of candidate solutions. The optimisation seeks to optimise with regard to a given measure of quality; equation 22.

The optimisation functions by having a population of candidate solutions, or particles, and moving these particles around in the search space according to simple mathematical formulae. The movements of the particles are guided by the best found positions in the search space for each particle, as well as the best known position for the entire population. When improved positions are discovered these will then come to guide the movements of the population. The process is repeated through multiple iterations until a satisfactory solution is reached (i.e. a good match to the measured count rates).

Consider the number of particles in the population to be S. Each particle within the population comprises of n point activity sources each having an activity A and solution vector q(x, y, z, A) within the location. Then the approach can be though of as having a function f(q) to be minimized where P is the best known solution for particle i, and G is the best known solution for the entire population.

The analogy with the generic PSO algorithm above and the measurement scenario being considered is clear. The population or ‘swarm’ will move within the search space finding those solutions that generate a good match with the count rates measured by each detector or measurement position. The population of solutions are then used in Equation (24) to derive the required calibration efficiency.

As mentioned above, and described in more detail below, instead of using the population of solutions to give a calibration efficiency, it is possible to use them to generate the solutions in terms of its total activity directly.

Other optimisation approaches can be used, such as simplex optimisation, ant colony optimisation or others which allow activity sources to be considered and varied in terms of their positions and activities. One such form of optimisation is a swarm optimisation type approach known as Artificial Bee Colonies or ABC; see Towards Hybrid and Adaptive Computing: A Perspective by A Shukla et al, Springer 21 Sep. 2010 and other references. The algorithm in this type of optimisation again advances a population or “swarm” within a population space towards better matches.

### Convergence Criteria.

This section describes the method by which the optimisation using the computational method 13 acting upon the computed data sets 21 from the mathematical model 15, PSO optimisation, is terminated. The termination is based upon meeting a set of criteria derived from the individual measured count rates and their uncertainties.

The method for termination used in the method is different from that employed traditionally. Usually an optimisation routine is terminated when the objective function to be minimised reaches a minimum defined value, remains constant or varies little for a fixed number of iterations or when a fixed number of iterations have been performed.

In the method of the invention, termination is performed when the agreement between the measurement data set 11 and the computed data set 21 is deemed acceptable. For the method, ‘acceptable’ requires both the ‘shape’ of the computed data set 21 and the measurement data set 11 (for instance as count rates) to be in agreement within a defined uncertainty and the difference between the computed data set 21 and the measurement data set 11 (for instance as total measured and computed count rate) to be within a predefined tolerance.

Such a determination of acceptability can be provided in various ways, but one approach involves considering the optimisation outcome against its position on a plot of computed data set against measured data set. Ideally, such a plot has a constant gradient and passes through the x and y axes at 0. The tolerances can be set above and below this line by further lines having their own equation in terms of form and intercept. An example would be a tolerance to one side which is also a straight line, but intercepts the y axes at a positive value and a tolerance to the other side which is also a straight line, but which intercepts the y axes at a negative value.

Other examples would include a requirement for the count rate for a source to be within a given count rate tolerance of the count rate for the matching source in the measurement results and/or a total count rate within a given count rate tolerance of the total count rate from the measurement results.

Unlike traditional methods where the optimisation method will converge (ideally) to the same solution irrespective of the starting conditions, the method of the invention is repeated (with different starting points for the computed data set 21 or inputs which generate it), with each repeat terminated when an acceptable solution is found. The results are stored for future analysis. The combination of the results from these repeats is used to determine the calibration efficiency described below and/or the more direct route to total activity separately described below.

The method allows for the possibility of more than one distribution of activity sources ‘matching’ the measurement data set 11, whereas the traditional approach aims to seek a unique solution based upon an assumed absolute and unique global minimum.

The new approach also takes into account the statistical uncertainty in the measured count rates and allows the user to define a systematic uncertainty for the mathematical model.

### Calibration Efficiency Concept

The total measured count rate needs conversion to give the total activity estimate; that is conversion from consideration in terms of the detected part of the emissions as detected into all of the emissions as emitted. This requires a calibration efficiency, i.e.:

$${A}^{meas} = \frac{{C}_{T}}{{θ}_{cal}} \qquad [ 3 ]$$

where A^{meas} is the measured activity and θ_{cal} is the calibration efficiency.

The true total activity within the location is given by the sum of the activities of the individual activities:

$${A}^{true} = {\sum }_{i = 1}^{n} {A}_{i} \qquad [ 4 ]$$

where A^{true} is the total activity.

Combining the above expressions of the total measured count rate, measured activity and total activity the following expression is reached:

$$\frac{{A}^{meas}}{{A}^{true}} = \frac{1}{{θ}_{ca l}} ( \frac{{\sum }_{i = 1}^{n} {A}_{i} {θ}_{i} ( x , y , z )}{{\sum }_{i = 1}^{n} {A}_{i}} ) \qquad [ 5 ]$$

In an ideal measurement the measured activity thatches the total activity within the location, i.e.:

$$\frac{{A}^{meas}}{{A}^{true}} = 1 \qquad [ 6 ]$$

The above two equations can then be combined to give an expression for the calibration efficiency:

$${θ}_{ca l} = \frac{{\sum }_{i = 1}^{n} {A}_{i} {θ}_{i} ( x , y , z )}{{\sum }_{i = 1}^{n} {A}_{i}} \qquad [ 7 ]$$

Thus, an exact measurement of total activity will be obtained if the calibration efficiency can be determined.

In prior art approaches, an assumption was made for the calibration efficiency.

The present invention contrasts with prior art approaches in seeking a calculated determination for the calibration efficiency or a determination of the source activities, obtained directly from optimisations, that does not rely on any such assumption.

### Example of Prior Art Approach

In this approach, it is necessary to define a value for the calibration efficiency prior to making the measurements. Since it is not possible to know the position or the number of activity sources prior to making the measurement, assumptions are made to enable the calibration efficiency equation to be solved.

If we assume that only a single activity source is present in the location, then the equation becomes:

θ_{cal}=θ₁(x,y,z) [8]

In such a case, the calibration efficiency is based upon a single activity source in the location. This is rarely going to be the actual position for the location. However, a careful review of the form of the calibration equation reveals that the expression is in fact a weighted average over the efficiencies for all the activity sources, each weighted on its own activity. Therefore, assuming that the activity or ‘weighting’ factors for each activity source are the same (i.e. assume that each activity source within the location has the same activity) then the calibration efficiency can be written as:

$${θ}_{ca l} = \frac{{\sum }_{i = 1}^{n} {A}_{i} {θ}_{i} ( x , y , z )}{{\sum }_{i = 1}^{n} {A}_{i}} = \frac{{\sum }_{i = 1}^{n} {θ}_{i} ( x , y , z )}{n} \qquad [ 9 ]$$

Again, the assumption that each source has the same activity will rarely be a valid one.

The only solution of this equation that is not dependent upon the position of the activity source within the location is when the number of activity sources is large, i.e.:

n→∞.

Again this assumption may not actually apply. In such a case, the calibration efficiency becomes:

$${θ}_{ca l} = {\vert \frac{{\sum }_{i = 1}^{n} {θ}_{i} ( x , y , z )}{n} \vert}_{n = ∞} = {θ}_{UD} \qquad [ 10 ]$$

This calibration efficiency is exactly equivalent to that obtained from a ‘uniform’ distribution of activity sources arranged uniformly, both spatially and in activity, within the location. From hereon this particular solution will be referred to as the ‘uniform distribution’ solution having a calibration efficiency equal to the ‘uniform distribution’ efficiency.

The uniform distribution efficiency can be used to convert measured count rates into activity values. However, the validity of doing so will depend upon how far it can be argued that the assumptions used correspond to the most ‘likely’ or ‘probable’ distribution of sources and activity within a search space. Whilst true in some cases it is important to recognise the conditions under which such an argument is valid (i.e. a large number of sources of equal activity uniformly distributed spatially within the search space).

Assuming the ‘uniform distribution’ assumption best represents the nature of the activity distribution within the location then we can now write our measurement result in terms of a ‘Best Estimate’, ‘Maximum’ and ‘Minimum’ activity given by the following:

$$\begin{matrix}{A}^{Best} = \frac{{C}_{T}}{{θ}_{UD}} & [ 11 ] \\ {A}^{M ax} = ( \frac{{C}_{T} + σ {C}_{T}}{{θ}_{UD}} ) \times {GMU}^{+} & [ 12 ] \\ {A}^{M i n} = ( \frac{{C}_{T} - σ {C}_{T}}{{θ}_{UD}} ) \times {GMU}^{-} & [ 13 ]\end{matrix}$$

where GMU⁺=a positive uncertainty component associated with the calibration efficiency θ_{UD}; GMU⁻=a negative uncertainty component associated with the calibration efficiency θ_{UD}

Here the positive and negative uncertainty components as those factors which we must multiply our ‘Best Estimate’ of activity to account correctly for the assumptions we have made in the use of the ‘uniform distribution’ efficiency. The uncertainty components can therefore be expressed through the calibration equation as:

$${GMU}^{+} = \frac{{θ}_{UD}}{{( \frac{{\sum }_{i = 1}^{n} {A}_{i} {θ}_{i} ( x , y , z )}{{\sum }_{i = 1}^{n} {A}_{i}} )}^{m i n}} \\ {GMU}^{-} = \frac{{θ}_{UD}}{{( \frac{{\sum }_{i = 1}^{n} {A}_{i} {θ}_{i} ( x , y , z )}{{\sum }_{i = 1}^{n} {A}_{i}} )}^{ma x}} \qquad [ 14 ]$$

Note that the denominators in both cases represent minimum and maximum values based upon any prior knowledge of the activity distribution within the location or any assumptions built into the choice of calibration efficiency.

Clearly if we could demonstrate with high confidence prior to the measurement that the sources and their activities were distributed truly uniformly within the search space then both uncertainty components would equate to unity and no uncertainty in our calibration efficiency exists in our result. This situation is rarely justifiable.

A common way to interpret the denominators in the above equation is to consider them as ‘bounding’ values taken from the distribution of all their possible values taking into account any assumptions we choose to apply to the measurement (i.e. number of sources, distribution of activity etc).

For example, assume that a single point activity source or ‘hotspot’ of activity has a high probability of occurring and we want to be 100% confident that our uncertainty factors when applied to our measurement result provide full coverage of the true or actual activity within the location. In this case, since it is possible that a single point activity source or ‘hotspot’ may exist, the limiting values are the positions in the arbitrary volume having the minimum and maximum net detection efficiencies for our measurement geometry.

In complete contrast, the method of the present invention uses the measurement data in such a way that the calibration equation can be solved explicitly i.e. determine the calibration efficiency and any uncertainty components from the information contained within the measurement data itself. In this way the ‘bounding’ values described above are significantly reduced in size producing a more accurate measurement.

### Determination of Calibration Efficiency

In the previous section it was proposed that if an exact solution to calibration efficiency equation:

$${θ}_{PSIM} = \frac{{\sum }_{i = 1}^{n} {A}_{i} {θ}_{i} ( x , y , z )}{{\sum }_{i = 1}^{n} {A}_{i}} \qquad [ 18 ]$$

could be found then the activity within the location can be define as:

$${A}^{PSIM} = \frac{{C}_{T}}{{θ}_{PSIM}} \qquad [ 19 ]$$

The method seeks this solution by perform multiple measurements at various measurement positions around the location. If M measurements are performed then the total measured count rate can be defined as:

$${C}_{T} = {\sum }_{j = 1}^{M} {C}_{j} \qquad [ 20 ]$$

where j are the measurement positions.

The measured count rates at each measurement position are a function of the distribution of the activity sources. The distribution is the combination of the actual activity source positions and their activities. By considering the location as containing a total of n discrete point activity sources, it is possible to represent the distribution of the activity sources as a sequence of source activities at discrete positions. Hence, the set of measured count rates may be rewritten:

$${\hat{C}}_{1} = {A}_{1} {ɛ}_{1 , 1} + {A}_{2} {ɛ}_{1 , 2} + … {A}_{n} {ɛ}_{1 , n} \\ ⋮ \\ {\hat{C}}_{M} = {A}_{1} {ɛ}_{M , 1} + {A}_{2} {ɛ}_{M , 2} + … {A}_{n} {ɛ}_{M , n} \qquad [ 21 ]$$

Having obtained a set of measured count rates, as detailed above in the previous section discussing experimental determination, the correspondence of a potential distribution of activity sources may be examined by evaluating the agreement between the estimated count rates given by the previous equations and the measured count rates. A good measurement of the correspondence or agreement is given by the following objective function:

$$OBJ = {\sum }_{j = 1}^{M} {( \frac{{C}_{j} - {\hat{C}}_{j}}{{C}_{j}} )}^{2} \qquad [ 22 ]$$

This objective is a function of the set of measured count rates and those functions that are dependent upon the actual location geometry. The actual location geometry comprises detector response, detector position, location/waste item geometry and composition etc, and the unknown distribution of the activity sources (activities and positions/efficiencies).

Collecting all the unknown parameters into a vector p we can write:

$$OBJ ( p ) = {\sum }_{j = 1}^{M} {( \frac{{C}_{j} - {\hat{C} ( p )}_{j}}{{C}_{j}} )}^{2} \qquad [ 23 ]$$

The basis of the computational method is to determine the minimum value of the objective function above. This can be done using a technique known as Particle Swarm Optimisation, PSO. This is described in detail below.

When the minimum value (or a reduced value) for the objective function is obtained in this way, it will contain result values for the distribution of the activity sources, expressed as activities and efficiencies in the manner given by equations [21].

Having reached this stage, to determine the best measure of total activity, two approaches can be considered.

The first approach uses these optimised values in the calibration efficiency equation [18] to calculate the value for the calibration efficiency. Since it is probable that there is no single unique (global) minimum, the PSO process is repeated Q times, with the final calibration efficiency being given by:

$${θ}_{PSIM} = \frac{{\sum }_{k = 1}^{Q} {\sum }_{i = 1}^{n} {A}_{i , k} {θ}_{i , k}}{{\sum }_{k = 1}^{Q} {\sum }_{i = 1}^{n} {A}_{i , k}} \qquad [ 24 ]$$

The uncertainty associated with this estimate of the calibration efficiency is determined from the distribution in the Q individual minimised solutions at a defined confidence level a, i.e.:

$$\begin{matrix}{\vert {θ}_{PSIM} \vert}^{max} = Percentile ( {\vert \frac{{\sum }_{i = 1}^{n} {A}_{i} {θ}_{i}}{{\sum }_{i = 1}^{n} {A}_{i}} \vert}_{All Q} , 1 - α ) & [ 25 ] \\ {\vert {θ}_{PSIM} \vert}^{min} = Percentile ( {\vert \frac{{\sum }_{i = 1}^{n} {A}_{i} {θ}_{i}}{{\sum }_{i = 1}^{n} {A}_{i}} \vert}_{All Q} , α ) & [ 26 ]\end{matrix}$$

Alternatively, in the second approach, the method uses the individual source activities in equation [21] resulting from the optimisation. These values can be used directly to calculate a best measure of total activity. Further information on this is provided below.

In either event, the methods of the present invention will yield significantly more accurate solutions than ‘conventional’ assay methods; equations [11], [12] and [13]. The uncertainties associated with the result will be significantly smaller because they are based upon a reduced ‘set’ of possible distribution of activity source solutions that ‘match’ the measurement data set. Prior art investigation methods must base their uncertainties on all possible distributions of activity source solutions and should be based therefore (to provide full uncertainty coverage) upon the possibility of a single point activity source or ‘hotspot’ of activity being present in the location. The uncertainty components given above are therefore calculated when this single activity source is located at the extremes of the possible efficiencies within the location.

In complete contrast the approach of the present invention needs only consider these extreme cases if the count rates expected from these positions are solutions found by the optimisation described.

Obtaining Further Declared Results from the Calibration Efficiency

Providing a solution to the calibration equation can be found, as detailed above, then the solution of the present method can be used to give a best measure of activity given by:

$${A}^{Best} = \frac{{C}_{T}}{{θ}_{PSIM}} \qquad [ 15 ]$$

a measure of maximum activity given by:

$${A}^{Max} = \frac{{C}_{T}}{{\vert {θ}_{PSIM} \vert}^{min}} \qquad [ 16 ]$$

and a measure of minimum activity given by:

$${A}^{Min} = \frac{{C}_{T}}{{\vert {θ}_{PSIM} \vert}^{max}} \qquad [ 17 ]$$

where |θ_{PSIM}|^{max} and |θ_{PSIM}|^{min} represent the positive and negative uncertainty component associated with θ_{PSIM}.

### Obtaining Further Declared Results From the Population Total Activities

Unlike the previous method, where the best measure of activity is calculated using a calibration efficiency, in this method the total activities of the optimized solutions can be used. Each optimization yields an activity value for each source, the sum of which yields a total activity. The solution set of total activities are used to calculate a best measure of activity. This can include the solution set average (as shown below), the solution set median or any other method which characterizes the distribution of solutions.

The best measure of the total activity may be given by:

$${A}_{PSIM} = \frac{{\sum }_{k = 1}^{Q} {\sum }_{i = 1}^{n} {A}_{i , k}}{Q} \qquad [ 27 ]$$

A measure of the maximum total activity may be given by:

$${\vert {A}_{PSIM} \vert}^{max} = Percentile ( {[ {\sum }_{i = 1}^{n} {A}_{i} ]}_{All Q} , 1 - α ) \qquad [ 28 ]$$

A measure of the minimum total activity may be given by:

$${\vert {A}_{PSIM} \vert}^{min} = Percentile ( {[ {\sum }_{i = 1}^{n} {A}_{i} ]}_{All Q} , α ) \qquad [ 29 ]$$

### Example Methodology

In this section the method of implementation are considered according to one non-limiting embodiment. The sequence of events is shown in FIG. 3, with each step described in more detail in the remainder of this section.

### Step #1: Perform Gamma-Ray Measurements Around Waste Item

Perform M measurements around the location. The measurement positions (i.e. co-ordinates of the centre point of the front face of the detector device and the detector normal) are recorded relative to the location. At each measurement position the count rate, count rate uncertainty and count rate corresponding to the minimum detectable activity is calculated. These are used as inputs into the algorithm.

### Step #2: Configure Mathematical Model

The mathematical model described above is configured to represent the measurement geometry and develop a definition of the search space and its content. The model definition includes the following:
Surfaces that define the geometry expressed in quadric notation (see Equation 28);
Cell to Surface mapping (i.e. each cell must be defined by its ‘sense’ with respect to its bounding surfaces);
Definition of all cell material densities;
Definition of all cell mass attenuation coefficients for the gamma-ray energy of interest;
Declaration of activity source cells within the geometry;
Measurement locations (i.e. x, y, z co-ordinates of the centre point of the front face of the detector device);
Area of the front face of the detector device;
Intrinsic efficiency of the detector device for the gamma-ray energy of interest;
Definition of detector device normal vector at each measurement position.

### Step #3: Configure Acceptance Criteria and Calculate Number of Sources to Image

This routine configures the criteria for terminating the imaging routine and reaching the results. This is described in detail above.

This step also determines the number of activity sources to be imaged in the method. The methodology is to use the minimum number of activity sources that produce a good fit between measured data set and the computed data set in terms of the measured and imaged count rates (i.e. the least number of activity sources that produce a successful convergence test as described in below). This approach therefore assumes that it is more likely to have discrete ‘hotspots’ of activity within the waste item rather than a uniform distribution. In addition the user is able to specify a number of ‘additional’ activity sources to be added to this minimum.

In the event of non-convergence then it is not possible to produce an imaged solution and only the solution is that given by Step #5a below and this forms the result.

### Step #4: Perform Optimisation

This step performs the optimisation, and hence provides the imaging and outputs the information required in order to calculate the total activity and the distribution of activity within the search space. The step includes a number of sub-steps.

Sub-Step #4a—Optimisation

In this sub-step, the measured data set and the computed data set are compared. The result is provided to the next sub-step, sub-step #4b.

In further iterations around the loop provided by the sub-steps of step #4, sub-step #4a also provides for the variation in the population of candidate solutions (the particles in the swarm) which are considered by the model to give the revised computed data set.

Sub-Step #4b—Acceptance

In this sub-step, the convergence criteria are considered. A yes/no decision is made. A no decision results in a further iteration within that optimisation and the method loops back to sub-step 4a. A yes decision results in that optimisation ending and the method moves on to sub-step 4c.

Sub-Step #4c—Saving of Optimised Solution

In this sub-step, the optimised solution obtained in sub-set 4b for that optimisation is saved. This details the positions, activities and efficiencies for that optimisation. The method progresses to sub-step #4d.

Sub-Step #4d—Further Optimisations

As mentioned above, the methodology seeks multiple optimisations and so this sub-step checks on the number of optimisations so far in the method's operation and either returns the method to sub-step 4a to start a new optimisation or moves on to sub-step 4e where enough optimisations have now been completed.

Sub-Step 4e—Combined Calibration Efficiency

As a result of the multiple optimisations, the method has stored solutions for each optimisation. On exiting the routine the imaged positions, activities and efficiencies (x, y, z, A, ε) for each of the solutions/simulations are available and these can be used to determine an overall calibration efficiency. This data is required for the analysis performed in Step #5.

### Step #5: Generate Assay Results

This step calculates the activity inventory within the location from the output overall calibration efficiency and the measured activity result based upon the ‘Conventional’ method; sub-step #5a.

In addition an image is produced showing the distribution of activity within the location based upon the new method and the imaging it provides; sub-step #5b.

### Sub-Step #5a: Calculate ‘Conventional’ Result

The assay result is based upon the total count rate measured and its uncertainty. The ‘Best Estimate’, ‘Maximum’ and ‘Minimum’ activities in terms of the GMU components and the calculated uniform distribution efficiency are given by:

$${A}_{Best}^{CONV} = \frac{{C}_{T}}{{θ}_{UD}}$$

$${A}_{Max}^{CONV} = \frac{{GMU}^{+}}{{θ}_{UD}} ( {C}_{T} + {n}^{σ} σ {C}_{T} )$$

$${A}_{Min}^{CONV} = \frac{{GMU}^{-}}{{θ}_{UD}} ( {C}_{T} - {n}^{σ} σ {C}_{T} )$$

where
n^{σ}=number of standard deviations;
GMU⁺, GMU⁻ and θ_{UD} are calculated from the ‘Efficiency Profiling’ which is provided by: Sample n point sources Z times within the SOURCE cells defined in the PSIM model.

For each sample determine the net detection efficiency at each measurement position i.e.

εᵢ=net detection efficiency at measurement position i

From the distribution in efficiency values calculate the average efficiency or uniform distribution efficiency i.e.:

$${θ}_{UD} = \frac{1}{Z} {\sum }_{i = 1}^{Z} {θ}_{i} ( x , y , z )$$

From the distribution in efficiency values calculate upper and lower efficiencies based upon a defined confidence level a, i.e.:

θ_{MAX}=Percentile(θ_{i=1 to Z},1−α)

θ_{MIN}=Percentile(θ_{i=1 to Z},α)

Calculate the positive and negative uncertainty components (see Equation 14).

$${GMU}^{+} = \frac{{θ}_{UD}}{{θ}_{MIN}}$$

$${GMU}^{-} = \frac{{θ}_{UD}}{{θ}_{MAX}}$$

### Sub-Step #5b: Calculate Imaging Result

The result is based upon the gross count rate measured and its uncertainty. The difference between this result and the ‘conventional’ counting result calculated in Sub-step #5b is that the calibration efficiency used to convert the measured count rate into an activity is based upon the analysis solutions for the point activity source activities and their efficiencies (A, ε) for each of the simulations.

The PSIM ‘Best Estimate’, ‘Maximum’ and ‘Minimum’ activities are given by equations [15], [16], [17]. The efficiency values are given by equations [24] with the associated uncertainty given by equations [25] and [26].

The results p(x, y, z) for the simulations are used to graphically display the distribution of activity within the location, such as a waste item. Possibilities for display include a 3D representation or a series of 2D representations (for example data plotted in the x-y plane, x-z plane and y-z plane). Some examples are given below in relation to experimental results for activity sources in large bags of matrix material.

### Application of the Method to a Gamma Ray Investigation

In this section the method's model is applied to a gamma-ray assay. In the sections above the distribution of the activity sources was represented as a sequence of activity source at discrete positions, with the associated count rates written as:

$${\hat{C}}_{1} = {A}_{1} {ɛ}_{1 , 1} + {A}_{2} {ɛ}_{1 , 2} + … {A}_{n} {ɛ}_{1 , n} \\ ⋮ \\ {\hat{C}}_{M} = {A}_{1} {ɛ}_{M , 1} + {A}_{2} {ɛ}_{M , 2} + … {A}_{n} {ɛ}_{M , n} \qquad [ 27 ]$$

To calculate the count rates at the measurement positions a model that calculates the efficiencies for each particle (source of activity) within the population or swarm is used. If the efficiencies are known then the count rates at the measurement positions can be estimated.

The method uses the mathematical model and it is defined firstly by a series of quadric surfaces which define the measurement geometry for the location. A quadric surface is represented by the following expression:

Ax²+By²+Cz²+Dxy+Exz+Fyz+Gx+Hy+Iz+J=0 [28]

where A, . . . , J are constants

Surfaces, such as planes and cylinders, can easily be represented in this notation.

In addition to the surfaces that make up the measurement geometry it is necessary to define the cells within our geometry. The search space is divided into such cells. Each cell is defined by a series of ‘senses’ with respect to each quadric surface which uniquely defines the spatial extent of the cell volume within the measurement geometry. Each cell must be assigned a material density and mass attenuation coefficient corresponding to the gamma-ray of interest, see FIG. 4.

Activity sources in cells are noted as source cells and are identified as part of the geometry configuration. Only these activity source cells are allowed to contain activity sources. An example of a source cell would be the matrix within a drum. The wall of the drum itself might exemplify a cell which could not contain an activity source and so could not be a activity source cell. This approach ensures that the population or ‘swarm’ is constrained to exist only within activity source cells.

The final part of the method is to define the measurement positions at which the measurements were performed and the detector response thereat. The measurement positions are simply defined by the central (x, y, z) co-ordinates of the front face of the detector device within the measurement geometry. The orientation of the detector device with respect to the location, such as a waste item, is defined by the normal vector perpendicular to the front surface of the detector device.

The response of the detector device is defined by the area of the front face of the detector device and the intrinsic efficiency of the detector device as a function of the incident gamma-ray energy. This intrinsic efficiency is based upon gamma-rays incident normally onto the front face of the detector device (i.e. parallel to the defined normal vector). Note that the intrinsic efficiency of the detector device as a function of gamma-ray energy is the only parameter that requires pre-calibration. All other parameters are user defined and dependent upon the specific measurement geometry.

In the example provided the count rate at the detector device is estimated using the following expression:

$$\hat{C} = \frac{{A}_{d} cos ( μ ) {ɛ}_{int} {A}_{source}}{4 {π ( {d}_{1} + {d}_{2} + {d}_{3} )}^{2}} \times exp - ( {μ}_{1} {ρ}_{1} {d}_{1} + {μ}_{2} {ρ}_{2} {d}_{2} ) \qquad [ 29 ]$$

In the measurement geometry of FIG. 4, two cells #1 and #2 are defined. Both cells #1 and #2 are defined by four surfaces; three planes parallel to the x-y plane and a right circular cylinder parallel to the z axis.

In order to determine the count rate measured by the detector device at a measurement position it is necessary to determine the path lengths of the gamma-ray in cell #1 and cell #2. This is achieved by representing the directional vector of the gamma-ray in parametric form and solving for the points of intersection with each defined surface within the geometry. Having calculated all points of intersection the matrix path lengths required can be determined. These path lengths, along with the material (cell) parameters defined by the user, are used to evaluate the attenuation factor (right hand side of Equation 29).

The effect of the visible surface area of the detector changing with the location of the point source is approximated by taking the cosine of the incident angle the gamma-ray path makes with the detector normal.

The method and system only require minimal calibration. For instance, in the case of a gamma ray based investigation or measurement, the method only requires the intrinsic efficiency of the detector device to be known as a function of incident gamma ray energy. This calibration can be readily performed by using a known calibration source, such as a single multi-emitting gamma ray source of known activity.

### EXPERIMENTAL EXAMPLE

In order to test the performance of the method outlined above, a waste item of known geometry was configured. FIG. 5a, side view and FIG. 5b, plan view, show the arrangement of the waste item 1000 and the detector device 1002 within the location 1004. FIG. 5c, plan view, and FIG. 5d, side view show the position of re-entrant tubes 1006 which were positioned in the matrix 1008 to allow known activity sources to be provided in known positions.

The waste item geometry in question is for a “dumpy bag”; a flexible bag 1010 which confines the powder matrix 1008 during the measurements. The detector device 1002 employs an “open” collimator. The waste item 1000 sits on a turntable 1012 facilitating the multiple measurements required by the method from different measurement positions. In this case, 8 measurement positions were defined around the waste item, labelled A-H in FIG. 5b.

The measurements were performed using a single HRGS detector (40% efficient, intrinsic efficiency of 16.5% at 662 keV). A total of nine source positions were considered. In each case the Cs-137 source was located at one of the measurement positions shown in FIGS. 5c and 5d. Each position was identified by a radial position (i.e. X, Y and Z) and a height within the waste item (i.e. H1, H2 and H3). The activity of the Cs-137 source was 23 Mbq.

Results were calculated for each measurement using the “Conventional” method described above and the Particle Swarm Imaging (PSIM) method described above.

The “conventional” measurements used a single “fixed” detector position (as shown in FIG. 5a) during which the dumpy bag was rotated continuously for 40 minutes. The PSIM result was obtained from the analysis of 8 individual measurement spectra taken at the measurement positions labelled A-H in FIG. 5a. Each individual measurement was 5 minutes in duration (i.e. the same total count time as used in the “conventional” measurements).

The results obtained by the “conventional” method used the single measurement spectrum acquired in each case and the “uniform” distribution assumption described above. The GMU factors listed in Table A were calculated and applied to the results to generate the appropriate uncertainties. These were defined at the 99% confidence interval for a single point source or “Hotspot” of Cs-137 activity (662 keV gamma-ray emission).

TABLE A

| | Positive GMU Factor | Negative GMU Factor |
|---|---|---|
| Description | (GMU⁺) | (GMU⁻) |
| Single Measurement | 98 | 0.18 |
| Dumpy Bag Rotated | | |

For the PSIM analysis a model was generated for the geometry as described. The PSIM model required the definition of 12 surfaces and 7 cells. Table B shows the activity results for each of the nine source positions indicated. Again, the true activity was within the declared uncertainties (99% confidence interval).

It can be seen that the accuracy of the assay using the PSIM method is significantly improved when compared to the results obtained using the “conventional” method of analyses of the same data. Also the uncertainties associated with the PSIM method of analysis are significantly smaller than those obtained by the “conventional” analysis method.

TABLE B

| | | Conventional | | | PSIM | |
|---|---|---|---|---|---|---|
| | Conventional | Best | Conventional | PSIM | Best | PSIM |
| | Maximum | Estimate | Minimum | Maximum | Estimate | Minimum |
| Source | Activity | Activity | Activity | Activity | Activity | Activity |
| Position | (MBq) | (MBq) | (MBq) | (MBq) | (MBq) | (MBq) |
| X-H1 | 41.42 | 0.38 | 0.06 | 43.06 | 27.69 | 15.22 |
| Y-H1 | 186.90 | 1.71 | 0.27 | 48.40 | 20.70 | 1.29 |
| Z-H1 | 950.19 | 8.69 | 1.38 | 66.05 | 19.54 | 2.70 |
| X-H2 | 46.42 | 0.42 | 0.07 | 36.97 | 20.89 | 3.17 |
| Y-H2 | 261.97 | 2.40 | 0.38 | 53.33 | 22.14 | 0.36 |
| Z-H2 | 1082.19 | 9.90 | 1.57 | 66.42 | 22.35 | 1.86 |
| X-H3 | 29.32 | 0.27 | 0.04 | 25.38 | 13.86 | 0.99 |
| Y-H3 | 197.55 | 1.81 | 0.29 | 46.02 | 14.70 | 0.42 |
| Z-H3 | 1142.11 | 10.44 | 1.65 | 55.45 | 20.66 | 2.46 |
| Average | 437.56 MBq | 4.00 MBq | 0.63 MBq | 49.01 MBq | 20.28 MBq | 3.16 MBq |
| STDEV | | 108% | | | 20% | |
| Bias | | −83% | | | −12% | |

In addition the PSIM method of analysis generates a “pseudo” image of the activity distribution within the waste item. This image is built up from the positions associated with each optimised PSIM solution within the search space. Examples of the PSIM images associated with the nine measurements performed are shown in FIGS. 6a, 6b and 6c.

In each case, the point source locations returned by the PSIM imaging analysis are in good agreement with the true locations. The density of the “point” clustering provides a strong indication as to the most probable location of any “point” sources of activity. This “clustering” is most notable in the X-Y plane images (i.e. looking down into the dumpy bag from above) since only a single height detector was deployed therefore yielding poor discrimination in the z plane images. These “pseudo” images provide similar levels and forms of visualisation of the results to those generated by present expensive state of the art tomographic imaging systems (i.e. gamma-ray TGS assay systems).

1. A method of investigating for one or more activity sources in a location, the method comprising:
a) providing a detector device;
b) providing a location;
c) detecting at a measurement position one or more emissions from one or more of the activity sources;
d) detecting at one or more further measurement positions one or more emissions from one or more of the activity sources;
e) providing a measurement data set from the detected emissions;
f) providing a model of the location;
g) providing one or more candidate solutions for the position and/or activity for one or more model activity sources;
h) using the model to provide a computed data set;
i) comparing the measurement data set with the computed data set to obtain a measure of the match between the measurement data set and the computed data set;
j) making a decision based upon the measure of the match; k) given one decision, repeating at least steps g) to j);
l) given another decision, providing a declared result.

2. A method according to claim 1 in which the activity sources emits one or more forms of emission, the emissions including one or more of neutrons, alpha particles, beta particles or gamma rays.

3. A method according to claim 1 in which the model is a mathematical model and the model provide a model location geometry which is an approximation of the location in terms of one or more characteristics of the location, the one or more characteristics of the location including one or more of:
materials defining the location; materials in the location; attenuation properties of one or more or all of the materials defining the location and/or in the location;
radiological shielding properties of one or more or all of the materials defining the location and/or in the location;
the mass of material defining the location and/or in the location;
the geometry of one or more or all surfaces or parts thereof defining the location and/or in the location;
one or more or all of the measurement positions;
the size and/or orientation of elements defining the location and/or provided in the location.

4. A method according to claim 1 in which the model is provided with one or more further inputs, the one or more further inputs may be used by the model to provide one or more further computed data sets.

5. A method according to claim 4 in which the one or more further inputs are constrained from changing in respect of one or more of the inputs to the first computed data set and/or the one or more further inputs are not constrained from changing with respect to. one or more or all of: the position of one or more or all of the activity sources; and/or the activity of one or more or all of the activity sources; and/or the number of activity sources.

6. A method according to claim 1, in which step i) provides for the comparable terms of the measurement data set being compared with the comparable terms of a computed data set and/or of the first computed data set and/or one or more of the further computed data sets, with the comparison providing a measure of the match between the measurement data set and one or more computed data sets, a comparison which meets one or more parameters being deemed a solution.

7. A method according to claim 6 in which one or more of the solutions provide information to and/or are reported in the declared result or results.

8. A method according to claim 1 in which a comparison which meets one or more of the parameters causes the computational stage to stop and/or the method to progress to a results stage when the number of solutions and/or number of matches and/or number of repeats of the method meets or exceeds a limit.

9. A method according to claim 1 in which the declared result provide a measurement of one or more characteristics of the one or more activity sources, the one or more characteristics including one or more of:
the position of the activity source or positions of the activity sources;
the quantity of the activity source or quantities of the activity sources;
a distribution of the activity source or activity sources within at the location.

10. A method according to claim 1 in which the investigation provides a measure of one or more characteristics of the one or more activity source by further processing one or more of the characteristics of the one or more declared results.

11. A method according to claim 1 in which the one or more declared results include one or more characteristics for the one or more activity sources which include an activity value for one or more or each of the one or more activity sources and the further processing of the one or more characteristics provides one or more total activities for the one or more activity sources.

12. A method according to claim 11 in which the further processing of the one or more characteristics includes considering one or more or all of the total activities to define an optimized result, for instance an optimized total activity and/or a mean total activity and/or a median total activity and/or characteristic of the distribution of values for such total activities.

13. A method according to claim 1 in which the investigation provides information on the measurement accuracy obtained and/or on the measurement uncertainties

14. A method according to claim 1 in which the method provides for the declared results and/or processed overall characteristic including values for one or two or all three of:
$${A}_{PSIM} = \frac{{\sum }_{k = 1}^{Q} {\sum }_{i = 1}^{n} {A}_{i , k}}{Q} \qquad [ 27 ]$$
for instance as the best measure of total activity;
$${\vert {A}_{PSIM} \vert}^{max} = Percentile ( {[ {\sum }_{i = 1}^{n} {A}_{i} ]}_{All Q} , 1 - α ) \qquad [ 28 ]$$
for instance as a best measure of the maximum total activity;
$${\vert {A}_{PSIM} \vert}^{min} = Percentile ( {[ {\sum }_{i = 1}^{n} {A}_{i} ]}_{All Q} , α ) \qquad [ 17 ]$$
for instance as a best measure of the minimum total activity.

15. A system for investigating for one or more radioactive sources in a location, the system comprising:
a) a detector device, the detector being adapted to detect at a measurement position one or more emissions from one or more of the activity sources and to detect at one or more further measurement positions one or more emissions from one or more of the activity sources, the detector device and/or a component connected thereto being adapted to provide a measurement data set from the detected emissions;
b) a processor, the processor being provided with a model of the location, the processor being further provided with one or more candidate solutions for the position and/or activity for one or more model activity sources, the model being adapted to provide a computed data set;
c) a further processor, the further processor being provided with a comparator, the comparator being adapted to compare the measurement data set with the computed data set to obtain a measure of the match between the measurement data set and the computed data set, the further processor being adapted to making a decision based upon the measure of the match, the further processor being adapted to make one decision or another decision, the further processor being adapted to provide or caused the processor to be provided with another one or more candidate solution in response to a one decision, the further processor being adapted to provide a declared result in response to an another decision.
